(19) United States
(12) Patent Application Publication
(10) Pub. No.: US 2025/0226153 A1
(43) Pub. Date: Jul. 10, 2025

(54) INSULATING COMPOSITION, WINDING UNIT, AND METHOD FOR FORMING INDUCTOR STRUCTURE

(71) Applicants: SHANGHAI METAPWR ELECTRONICS CO., LTD, Shanghai (CN); HUIZHOU POCO NEW INDUCTOR TECHNOLOGY CO., LTD., Guangdong (CN)

(72) Inventors: Shouyu HONG, Shanghai (CN); Mingzhun ZHANG, Shanghai (CN); Xiongzhi GUO, Shanghai (CN)

(73) Assignees: SHANGHAI METAPWR ELECTRONICS CO., LTD, Shanghai (CN); HUIZHOU POCO NEW INDUCTOR TECHNOLOGY CO., LTD., Guangdong (CN)

(21) Appl. No.: 19/008,640

(22) Filed: Jan. 3, 2025

(30) Foreign Application Priority Data
Jan. 9, 2024 (CN) 202410031872.8

(51) Int. Cl. H01F 41/12; C08J 5/24

(52) U.S. Cl. CPC H01F 41/12; C08J 5/243; C08J 2383/04

(57) ABSTRACT

The application provides an insulating composition used in a winding unit of an inductor structure or between different winding units. The insulating composition comprises a fiber base material used for providing the strength of the insulating composition, an organic matter coated the fiber base material used for providing stress buffering, wherein the resistivity of the insulating composition after annealing is greater than or equal to 2 Mohm·m. The insulating composition provided by the application can provide stronger insulation performance after high-temperature annealing.

### CROSS-REFERENCE TO RELATED APPLICATIONS

This application claims the priority benefit of China patent application 202410031872.8 filed on Jan. 9, 2024. The entirety of the above-mentioned patent application is hereby incorporated by reference herein and made a part of this specification.

### BACKGROUND

### Background

In recent years, with the development of technologies such as data centers, artificial intelligence, supercomputers and the like, more and more powerful ASIC are applied, such as CPU, GPU, machine learning accelerators, network switches, servers and the like, which consume a large amount of current, for example, the required current can reach thousands of amperes; and the current has the characteristic of rapid jump. A voltage regulator module (VRM, Voltage Regulator Modules, i.e., a power converter module according to the present application), comprising a buck circuit (Buck), is conventionally used to supply such a load.

In the prior art, an anti-coupling inductor technology is usually adopted to solve the problem, and the anti-coupling inductor technology has relatively low leakage inductance, so that the anti-coupling inductor technology has relatively high transient response; meanwhile, the anti-coupling inductor has relatively high steady-state equivalent inductance, so that the efficiency is improved; and the anti-coupling inductor technology can meet the requirement of transient performance and the efficiency, so that the anti-coupling inductor technology is a technology commonly adopted by a VRM at present. The most important of the anti-coupling inductor technology is the design and manufacturing of the inductor.

An existing inductor generally comprises at least one winding and a magnetic core, the existing inductor generally adopts an integrally pressed inductor of the iron powder core and winding. Due to the fact that the machining process is simple, high automation and batch manufacturing are easy to achieve, the inductor is widely used. However, the magnetoelectric performance of the iron powder core is poor. In order to obtain a high-performance magnetic element, magnetic materials such as an iron-aluminum-silicon powder core (FeAlSi), an iron-nickel powder core (FeNi), an iron-nickel-manganese powder core (FeNiMo), an iron-silicon powder core (FeSi), an iron-silicon-chromium powder core (FeSiCr), a ferrite (for example, iron-nickel-zinc (FeNiZn), iron-manganese-zinc (FeMnZn) and other magnetic materials) need to be obtained. However, the high-temperature annealing/sintering process needs to be carried out on the magnetic elements made of the high-performance magnetic materials, the temperature usually needs to be 500° C. or above, and the annealing temperature of the special iron-aluminum-silicon powder core is near 700° C. A withstand voltage requirement needs to be met between windings of the anti-coupling inductor, so that an insulating material needs to be used for filling between the two windings. The annealing/sintering process temperature of the magnetic element is far superior to the temperature resistance value of the organic material. Meanwhile, when the magnetic core and the winding are co-pressed, the pressure is even as high as 10 tons per square centimeter, and the compressive strength of the generally inorganic material is far higher. Therefore, there is an urgent need for a material which is resistant to pressure and still maintains insulation performance after high temperature.

### SUMMARY

In view of the above, one of the objectives of the present application is to provide an insulating composition, used in a winding unit or between different winding units of an inductor structure, comprises:
a fiber base material for providing the strength of the insulating composition;
an organic matter, wherein the organic matter covers the fiber base material and is used for providing stress buffering;
the resistivity of the insulating composition after annealing is greater than or equal to 2 Mohm·m.

Preferably, the melting temperature of the fiber base material is smaller than the annealing temperature, and the cracking temperature of the organic matter is smaller than the melting temperature of the fiber base material.

Preferably, wherein at a normal temperature, a tensile strength in an extension direction of the fiber base material on a plane of the insulating composition is greater than or equal to 20 MPa.

Preferably, the fiber base material is at least one of glass fiber and ceramic fiber, and the organic matter is at least one of organic silicon, epoxy resin, polyvinyl alcohol, polyester, polyesterimide, polyimide and polyamide imide.

Preferably, the fiber base material is a glass fiber braided fabric, and the organic matter is organic silicon resin.

Preferably, the glass fiber braided fabric comprises warp yarns formed by a plurality of strands of fibers and weft yarns formed by a plurality of strands of fibers, and the organic silicon resin covers the periphery of the glass fiber braided fabric and is formed in the glass fiber braided fabric.

Preferably, wherein at normal temperature, the compressive strength of the organic matter is greater than or equal to 1.5 GPa.

Preferably, a method for forming a winding unit, comprises the following steps:
S1, providing at least one insulating composition;
S2, forming a first winding connecting piece on a first surface of at least one insulating composition, and forming a second winding connecting piece on a second surface opposite to the first surface to form a combined connecting piece;
S3, separating the combined connecting piece into at least one winding unit;
S4, pressing and forming the winding unit to form the winding unit, wherein the winding unit comprises a first winding, an insulating composition and a second winding which are sequentially stacked.

Preferably, wherein in the step S2, a combined connecting piece is formed in a pressing mode.

Preferably, wherein in the step S2, after the combined connecting piece is formed, a pattern is formed on the first winding connecting piece and the second winding connecting piece.

Preferably, wherein in the step S2, a pattern is formed on the first winding connecting piece and the second winding connecting piece before the combined connecting piece is formed.

Preferably, wherein in the step S2, the insulating composition is one, the first winding connecting piece is only a discrete first winding, and the second winding connecting piece is only a discrete second winding.

Preferably, wherein in the step S2, a combined connecting piece is formed to assemble the first winding, the insulating composition and the second winding.

Preferably, wherein in the step S2, the insulating composition is laminated on the upper surface and the lower surface of the combined connecting piece.

Preferably, a method for forming an inductor structure comprises the following steps:
S1, providing at least one winding unit formed by the forming method of the winding unit; providing at least one magnetic core or a magnetic core material;
S2, co-pressing the at least one winding unit and the at least one magnetic core or magnetic core material to form a combined body;
S3, performing high-temperature annealing on the combined body;
S4, impregnating the annealed combined body into an organic material;
S5, leading out pins to form an inductor structure, the inductor structure comprising a top surface, a bottom surface, a first side surface, and a second side surface opposite to the first side surface.

Preferably, the first winding and the second winding of the winding unit in the step S1 comprise a first end and a second end, and pins are arranged at the two ends of the first winding and the second winding.

Preferably, wherein pins at both ends of the first winding and the second winding are both located on the bottom surface of the inductor structure.

Preferably, wherein projections of pins at the same end of the first winding and the second winding do not overlap with each other in the thickness direction of the winding unit.

Preferably, wherein the winding unit comprises a first main surface and a second main surface which are opposite to each other, the winding unit further comprises a first side face and a second side face which are opposite, the first side face and the second side face are arranged on the side face of the main surface respectively, the winding unit further comprises a first end face and a second end face which are opposite, and the first end face and the second end face are arranged on the end face of the main surface respectively.

Preferably, a bending part is arranged at the tail end of a pin of the first winding; and a bending part is arranged at the tail end of a pin of the second winding.

Preferably, wherein a first winding of the winding unit is a first main winding, a second winding of the winding unit is a first auxiliary winding, the first main winding, the insulating composition and the first auxiliary winding are stacked in a width direction of the inductor structure, and pins at two ends of the first main winding and the first auxiliary winding are both located on a bottom surface of the inductor structure.

Preferably, at least one winding unit comprises a first winding unit and a second winding unit; a first winding of the first winding unit is a first main winding, and a second winding of the first winding unit is a first auxiliary winding; a first winding of the second winding unit is a second main winding, and a second winding of the second winding unit is a second auxiliary winding.

The first main winding, the insulating composition and the first auxiliary winding are stacked in the width direction of the inductor structure; the second main winding, the insulating composition and the second auxiliary winding are stacked in the width direction of the inductor structure.

The first auxiliary winding and the second auxiliary winding are adjacent in the width direction of the inductor structure at intervals.

In the step 2, the first winding unit and the second winding unit are arranged at intervals in the width direction of the inductor structure.

Preferably, wherein the first main winding and the second main winding have the same shape and extension direction, and the first auxiliary winding and the second auxiliary winding have the same shape and extension direction.

Preferably, wherein pins at both ends of the first main winding and the first auxiliary winding are both located on the bottom surface of the inductor structure; and pins at both ends of the second main winding and the second auxiliary winding are both located on the bottom surface of the inductor structure.

Preferably, wherein pins at two ends of the main winding are respectively located on a top surface and a bottom surface of the inductor structure, and pins at two ends of the first auxiliary winding and the second auxiliary winding are both located on a bottom surface of the inductor structure.

Preferably, wherein the first winding, the insulating composition and the second winding are stacked in the width direction of the inductor structure, the insulating composition serves as a nonmagnetic air gap material between the first winding and the second winding, and the coupling coefficient between the first winding and the second winding is adjusted by adjusting the thickness of the insulating composition.

Preferably, wherein a pin at one end of the first winding extends from a first side surface to a bottom surface of the inductor structure, and a pin at the other end of the first winding extends from a second side surface to a top surface of the inductor structure; the pin at one end of the second winding extends from the first side surface to the top surface of the inductor structure, and the pin at the other end of the second winding extends from the second side surface to the bottom surface of the inductor structure.

Preferably, wherein the insulating composition has a width, and the width of the insulating composition is greater than the distance between the first winding and the second winding in the width direction.

Preferably, an insulating composition is further arranged at the interval between the first winding unit and the second winding unit, the insulating composition serves as a nonmagnetic air gap material between the first winding unit and the second winding unit, and the coupling coefficient between the first winding unit and the second winding unit is adjusted by adjusting the thickness of the insulating composition.

Preferably, the shape and extension direction of the first auxiliary winding and the second auxiliary winding are the same; the pin at one end of the first main winding extends from the first side surface to the bottom surface of the inductor structure, and the pin at the other end of the first main winding extends from the second side surface to the top surface of the inductor structure; a pin at one end of the second main winding extends from the first side surface to the top surface of the inductor structure, and a pin at the other end of the second main winding extends from the second side surface to the bottom surface of the inductor structure.

Preferably, wherein in step S1, at least one magnetic core provided comprises a first magnetic core and a second magnetic core, or magnetic powder is provided as a magnetic core material; in the step S2, the winding unit and the magnetic core or the magnetic powder are co-pressed to form a combined body, wherein the first magnetic core, the winding unit and the second magnetic core are assembled in sequence and then put into a mold, and is pressed to form a combined body; or the winding unit is placed in the mold, the magnetic powder is filled, and then the winding unit and the magnetic powder are directly pressed to form the combined body.

Preferably, the first magnetic core and the second magnetic core are both provided with grooves adapted to the shape of the winding unit.

Preferably, a method for forming an inductor structure, comprising:
S1, providing at least one insulating composition, at least one first winding and at least one second winding;
S2, integrating the first winding and the insulating composition, and then performing pressing molding to form an integrated body; pressing and forming the second winding;
S3, bonding the integrated body with the second winding through an organic material to form a winding unit, wherein the insulating composition of the winding unit is located between the first winding and the second winding;
S4, co-pressing at least one of the winding units and at least one magnetic core or magnetic core material to form a combined body;
S5, performing high-temperature annealing on the combined body;
S6, impregnating the annealed combined body into an organic matter;
S7, leading out pins to form an inductor structure, the inductor structure comprising a top surface, a bottom surface, a first side surface, and a second side surface opposite to the first side surface.

Preferably, the first winding and the second winding of the winding unit in the step S4 comprise a first end and a second end, and pins are arranged at the two ends of the first winding and the second winding.

Preferably, wherein pins at both ends of the first winding and the second winding are both located on a bottom surface of the inductor structure, and main bodies of the first winding and the second winding intersect with each other.

Preferably, wherein a pin at one end of the first winding is located on the bottom surface of the inductor structure, and a pin at the other end of the first winding is located on the top surface of the inductor structure; a pin at one end of the second winding is located on the top surface of the inductor structure, and a pin at the other end of the second winding is located on the bottom surface of the inductor structure.

Preferably, wherein pins at both ends of the first winding and the second winding are located on the bottom surface of the inductor structure; and the main bodies of the first winding, the insulating composition and the second winding are sequentially stacked.

Preferably, wherein pins located at the same end of the first winding and the second winding extend away from each other, pins at both ends of the first winding and the second winding do not cover the insulating composition, and the insulating composition only extends along the bending portion of the first winding.

Compared with the prior art, the application has the following beneficial effects:
(1) The insulating composition provided by the application is used between windings or windings in an inductor, still keeps good insulation performance after undergoing high-temperature annealing, and has good tensile strength and compression resistance at normal temperature.

### BRIEF DESCRIPTION OF THE DRAWINGS

FIG. 1A to FIG. 1C are schematic diagrams of formation of a winding unit.

FIG. 2A is a schematic structural diagram of a winding unit, and FIG. 2B is a schematic diagram of an inductor structure corresponding to FIG. 2A.

FIG. 3A and FIG. 3C are schematic structural diagrams of a winding unit, and FIG. 3B is a bottom view of an inductor structure corresponding to FIG. 3A.

FIG. 4A is a schematic structural diagram of a winding unit, and FIG. 4B is a schematic diagram of an inductor structure corresponding to FIG. 4A.

FIG. 5 is a schematic structural diagram of a winding unit.

FIG. 6 is a schematic structural diagram of a winding unit.

FIG. 7 is a schematic structural diagram of a winding unit.

FIG. 8A is a schematic diagram of an inductor structure, and FIG. 8B is an exploded view corresponding to FIG. 8A.

FIG. 9A is a schematic diagram of an inductor structure, and FIG. 9B is an exploded view corresponding to FIG. 9A.

FIG. 10A is a schematic diagram of an inductor structure, and FIG. 10B is an exploded view corresponding to FIG. 10A.

FIG. 11A is a schematic diagram of an inductor structure, and FIG. 11B is an exploded view corresponding to FIG. 11A.

FIG. 11C is a schematic diagram of another inductor structure according to Embodiment 9, and FIG. 11D is an exploded view corresponding to FIG. 11C.

FIG. 12A is a schematic diagram of an inductor structure, and FIG. 12B is an exploded view corresponding to FIG. 12A.

FIG. 13A is a schematic structural diagram of a winding unit, and FIG. 13B is a schematic diagram of an inductor structure corresponding to FIG. 13A.

FIG. 14A is a schematic structural diagram of a winding unit, and FIG. 14B is a schematic diagram of an inductor structure corresponding to FIG. 14A.

FIG. 15 is a schematic structural diagram of a winding unit.

### DESCRIPTION OF THE EMBODIMENTS

The application provides an insulating composition. On one hand, the insulating composition is used in a winding, on the other hand, the insulating composition can be used between different windings, after high-temperature annealing is carried out, the insulating composition still keeps good insulating performance, and meanwhile, the insulating composition has good pull-up strength and compression resistance at normal temperature (equivalent to before annealing).

According to the technical scheme in the embodiment of the application, the technical scheme in the embodiment of the application is clearly and completely described below in combination with the drawings in the embodiment of the application, obviously, the described embodiments are only a part but not all of the embodiments of the present application. All other embodiments obtained by a person of ordinary skill in the art based on the embodiments of the present application without creative efforts shall fall within the protection scope of the present application.

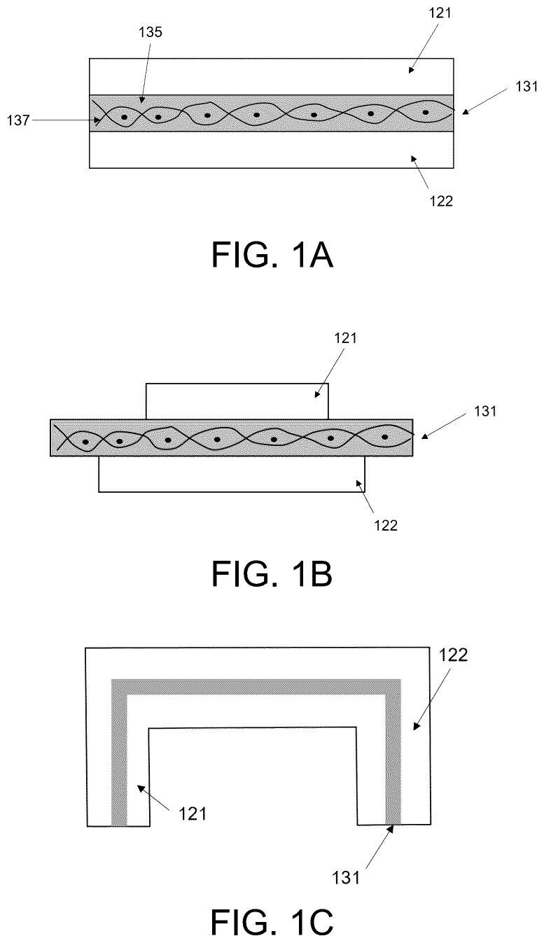

FIG. 1A to FIG. 1C are schematic diagrams of formation of a winding unit. As shown in FIG. 1C, the winding unit 100 comprises a first winding 121, a second winding 122, and an insulating composition 131. The first winding 121, the insulating composition 131, and the second winding 122 are sequentially stacked.

The insulating composition 131 is used in a winding unit or between different winding units of an inductor structure, the insulating composition 131 comprises a fiber base material 137 and an organic matter 135, and the fiber base material 137 is used for providing the strength of the insulating composition at normal temperature; and the organic matter 135 covers the fiber base material 137 and is used for providing stress buffering. Preferably, the organic matter covers the fiber base material by impregnating the fiber base material with an organic matter.

Preferably, the compressive strength of the organic matter at normal temperature is greater than or equal to 1.5 GPa. The resistivity of the insulating composition after annealing (the annealing temperature is generally greater than 500° C.) is greater than or equal to 2 Mohm·m. The insulating composition provided by the application can provide excellent tensile strength and compression resistance at normal temperature, and is outstanding in insulating property after high-temperature annealing treatment.

The melting temperature of the fiber base material is smaller than the annealing temperature, the cracking temperature of the organic matter is smaller than the annealing temperature, and further, the cracking temperature of the organic matter is smaller than the melting temperature of the fiber base material. Generally, the annealing temperature is at least 500° C., the annealing temperature is related to the selection of the magnetic core material. The cracking temperature is the corresponding temperature when the organic matter is cracked and the weight loss is 5%.

At normal temperature, the tensile strength in the direction of extension of the fiber base material on the plane of the insulating composition is greater than or equal to 20 MPa.

Optionally, the fiber base material is at least one of glass fiber and ceramic fiber, and the organic matter is at least one of organic silicon, epoxy resin, polyvinyl alcohol, polyester, polyesterimide, polyimide and polyamide imide. Further preferably, the fiber base material is a glass fiber braided fabric, and the organic matter is organic silicon resin. Preferably, the glass fiber braided fabric is at least one of E glass fibers and S glass fibers with a melting temperature of about 650 degrees. The glass fiber braided fabric comprises warp yarns formed by a plurality of strands of fibers and weft yarns formed by a plurality of strands of fibers, and the organic silicon resin covers the periphery of the glass fiber braided fabric and is formed in the glass fiber braided fabric.

According to the application, the glass fiber braided fabric is used as a supporting base material, so that the strength at normal temperature is greatly improved; the tensile strength along the stretching direction of the fiber is greater than or equal to 20 MPa, so that the integrity of the structure can be kept in the forming process of the winding; and the glass fiber braided fabric is provided with warps and wefts, so that the toughness and the strength are improved; when the glass fiber braided fabric is wrapped with the organic matter into subsequent pressing, stress buffering is provided, and the integrity of the glass fiber is furthest protected. The glass fiber braided fabric impregnating organic matter can greatly improve the content of the glass fiber, which is mainly due to the fact that the organic matter is easily and completely filled in the glass fiber braided fabric by adopting an impregnation method, and bonding between the insulating composition and the winding can be provided only through a very thin layer of organic matter on the surface of the glass fiber braided fabric. The improvement of the glass fiber content can greatly improve the insulation performance and mechanical performance between windings after high-temperature annealing. The glass particles are mixed with the organic material to form the insulating material, the filling amount of the glass particles can influence the viscosity and the mechanical strength of the insulating layer at normal temperature, and the manufacturability is poor. Moreover, when the inductor is pressed, the dislocation between the glass particles may cause the risk of insulation failure.

The application further provides a forming method of the winding unit The forming method comprises the following steps.

S1, providing at least one insulating composition 131.

Optionally, as shown in FIG. 1A, the insulating composition 131 in step S1 is an insulating composition layer, and comprises a first surface and a second surface opposite to each other.

S2, forming a first winding connecting piece on a first surface of at least one insulating composition 131, and forming a second winding connecting piece on a second surface opposite to the first surface to form a combined connecting piece.

Optionally, in the step S2, a combined connecting piece is formed by pressing, for example, the first winding connecting piece, the at least one insulating composition 131 and the second winding connecting piece are laminated and then pressed. Specifically, the first winding connecting piece and the second winding connecting piece are copper foils, and a combined connecting piece is formed to press the copper foil on the two sides of the at least one insulating composition 131. After forming the combined connecting piece, a pattern is formed on the first winding connecting piece and the second winding connecting piece. Optionally, before the combined connecting piece is formed, a pattern is formed on the first winding connecting piece and the second winding connecting piece, the pattern is formed through an etching process, and FIG. 1B exemplarily shows the pattern after the etching process. The first winding connecting piece is a connecting piece formed by connecting a plurality of first windings end to end, and the second winding connecting piece is a connecting piece formed by connecting a plurality of second windings end to end. FIG. 1A shows only a combination of an insulating composition 131, a first winding 121 and a second winding 122.

In other embodiments, a connector is provided between adjacent windings of the winding connecting piece, the connector being removed when separated into a winding unit in a subsequent step S3.

S3, separating the combined connecting piece into at least one winding unit.

Optionally, in the step S3, the combined connecting piece is separated into at least one winding unit through at least one of mechanical cutting or laser cutting. The winding unit is illustratively shown in FIG. 1B.

And S4, pressing and forming the winding unit to form the winding unit 100, wherein the winding unit comprises a first winding 121, an insulating composition 131 and a second winding 122 which are sequentially stacked, the shape of the winding unit is determined according to the design requirement of the inductor structure, the winding unit can be pressed into a “[”-shape, and the winding unit can be pressed into a “Z”-shape; or is any combination of “[”-shape and “Z”-shape; and FIG. 1C only exemplarily shows the situation of “[”.

In another embodiment, in the step S2, the insulating composition is one, the first winding connecting piece is only a discrete first winding, and the second winding connecting piece is only a discrete second winding, that is, the combined connecting piece is formed to assemble the first winding, the insulating composition and the second winding. In the embodiment, a winding unit is independently formed instead of a connecting piece, so that the step S3 can be omitted.

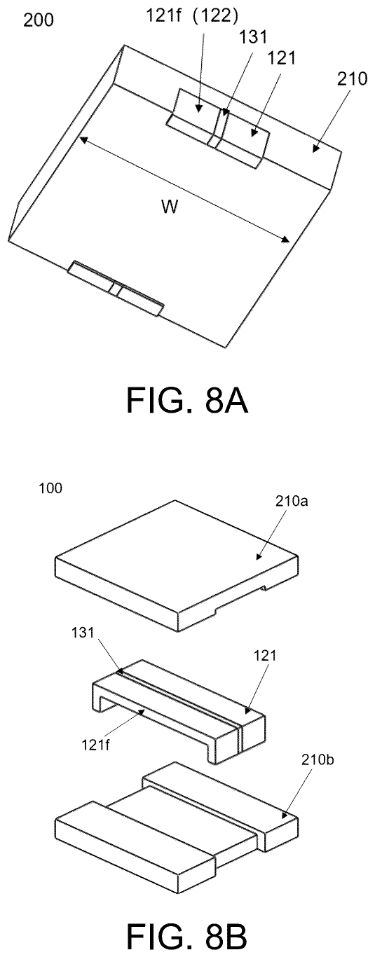

In other embodiments, as shown in FIG. 7, in the step S2, the insulating composition is repressed on the upper surface and the lower surface of the combined connecting piece, specifically, the insulating composition 131b is arranged on the upper surface of the combined connecting piece, the insulating composition 131a is arranged on the lower surface of the combined connecting piece, and the insulating composition 131a and 131b can wrap the winding unit, so that the winding unit is isolated from the magnetic core according to the requirement of the insulating performance of the magnetic core body, and more complete insulation is formed.

A winding unit of any shape can be formed according to the forming method of the winding unit.

The application further provides a forming method of the inductor structure 200. The forming method comprises the following steps.

S1, providing at least one winding unit 100 formed by the forming method of the winding unit; providing at least one magnetic core 210 or a magnetic core material.

Optionally, the provided at least one magnetic core comprises a first magnetic core and a second magnetic core, or provides magnetic powder as a magnetic core material. The number of the magnetic cores is selected according to the design of the inductor structure.

Optionally, the shape of the winding unit 100 is selected according to a design requirement of the inductor structure 200, for example, “[”-shaped, “Z”-shaped, or any combination of “[”-shaped and “Z”-shaped.

S2, co-pressing the at least one winding unit 100 and the at least one magnetic core 210 or the magnetic core material to form a combined body.

Optionally, the winding unit and the magnetic core or the magnetic core material are co-pressed to form a combined body, the first magnetic core, the winding unit and the second magnetic core are assembled in sequence and then put into a mold, and the mold is pressed to form a combined body; or the winding unit is placed in the mold, the magnetic powder material is filled, and then the winding unit and the magnetic powder material are directly pressed to form the combination body.

S3, performing high-temperature annealing on the combined body.

S4, impregnating the annealed combined body into an organic material.

S5, leading out pins to form an inductor structure 200, wherein the inductor structure comprises a top surface 211, a bottom surface 213, a first side surface 214 and a second side surface 216 opposite to the first side surface 214, and the inductor structure 200 is a cuboid.

In the step S3, the organic matter in the insulating composition is at least partially cracked in the annealing process, gaps generated by cracking of the organic matter are filled with the glass fibers, a microscopic porous but macroscopic continuous insulating structure is formed, and in the subsequent step S4, the gaps are filled with organic material in impregnated process, and the microscopic porous structure can be filled.

Optionally, in the step S3, the cracking temperature of the cracking of the organic matter is lower than the melting temperature of glass fiber, so that the influence of organic matter cracking exhaust gas when the glass fiber melts to repair the microscopic porous between the organic matter cracking products can be solved.

Optionally, in the step S5, the lead-out pin can adopt a laser windowing mode, then an electroplating mode is adopted, a sintered conductive paste can also be arranged after the window is opened, and copper, tin and other materials are plated on the conductive paste to form pins.

According to the forming method of the inductor structure, any inductor structure 200 can be formed. The insulation mode between the first winding and the second winding or between the winding units can provide good insulation of the winding unit; the insulation mode is also suitable for insulation between turns and turns in one winding, and is described only by taking the following inductor structure 200 as an example, but is not limited thereto.

### Embodiment 1

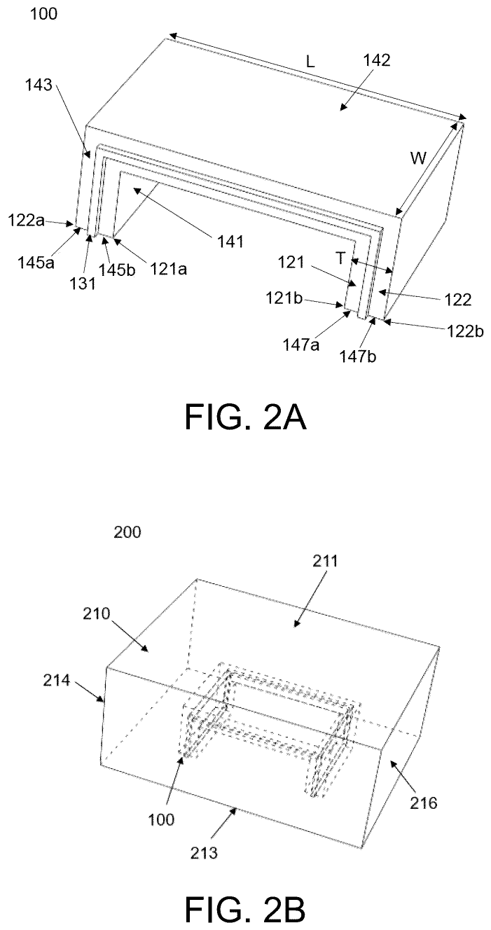

FIG. 2A is a schematic structural diagram of an embodiment of a winding unit, and FIG. 2B is a schematic structural diagram of an embodiment of an inductor structure 200. Meanwhile, referring to FIG. 2A to 2B, the inductor structure 200 comprises a magnetic core 210 and a winding unit 100, the winding unit 100 comprises a first winding 121, a second winding 122 and an insulating composition 131. The first winding 121, the insulating composition 131 and the second winding 122 are sequentially stacked. The first winding 121 of the winding unit 100 comprises a first end 145b and a second end 147a, the first winding is provided with a pin 121a at the first end, the first winding is provided with a pin 121b at the second end. The second winding 122 of the winding unit 100 comprises a first end 145a and a second end 147b, a pin 122a is arranged at the first end of the second winding, a pin 122b is arranged at the second end of the second winding. Specifically, in the step S5, the lead-out pin is used for leading out the first end and the second end of the first winding 121 out of the magnetic core 210 to form pins, and the first end and the second end of the second winding 122 are led out of the magnetic core 210 to form pins. The winding unit (or the first winding, the second winding and the insulating composition) comprises a first main surface 141 and a second main surface 142 opposite to each other, the winding unit further comprises a first side surface 143 and a second side surface opposite to each other, the first side surface 143 and the second side surface are respectively arranged on side surfaces of the main surface (the first main surface and the second main surface), the winding unit 100 further comprises a first end face and a second end face opposite to each other, and the first end face and the second end face are respectively arranged on end faces of the main surface (the first main surface and the second main surface), that is, the first end face is an end face of the first end, and the second end face is an end face of the second end. Optionally, the insulating composition 131 may exceed the range of the first winding 121 or the second winding 122, for example, the insulating composition 131 extends outwards from the first side surface 143 and the second side surface, and/or extends outwards on the first end surface and the second end surface, so as to further reduce variations such as tolerance and pressure in the processing process, thereby improving the safety of insulation. The main surface is a surface formed by a length direction L and a width direction W. Optionally, the winding unit 100 is “[”-shaped, and pins of both ends (the first end and the second end) of the first winding 121 and the second winding 122 (the first end and the second end) are located on the bottom surface 213 of the inductor structure 200. The insulating composition 131 can form good insulation performance between the first winding 121 and the second winding 122.

### Embodiment 2

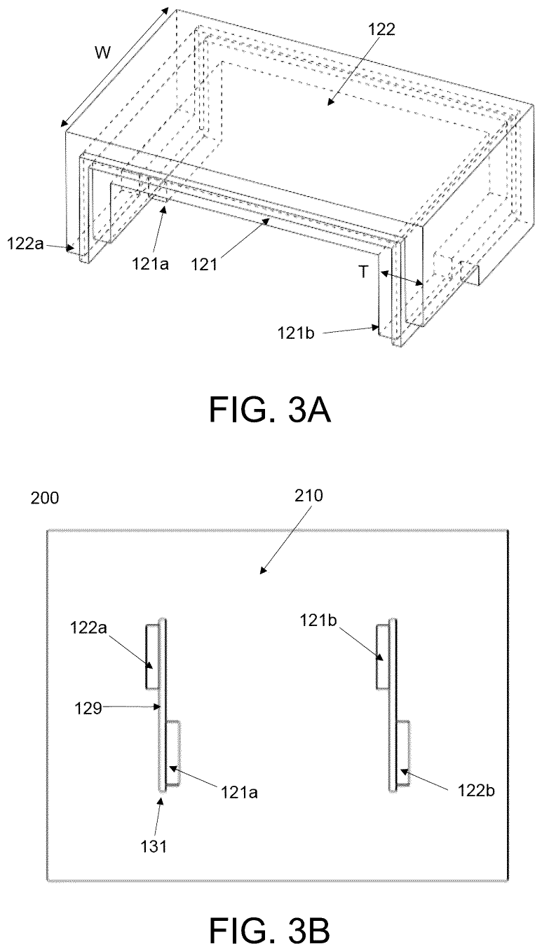

FIG. 3A is a schematic structural diagram of another embodiment of a winding unit, FIG. 3C is a schematic structural diagram of another embodiment of a winding unit, and FIG. 3B is a schematic structural diagram of another embodiment of an inductor structure. Referring to FIG. 3A to FIG. 3C, the difference between the embodiment and the first embodiment lies in that the projections of the pins of the same end (such as the first end or the second end) of the first winding 121 and the second winding 122 do not overlap with each other in the thickness direction T of the winding unit. That is, an avoiding area 129 is arranged between pins at the same end of the first winding 121 and the second winding 122 in the width direction W of the winding unit, and no pin exists in the avoiding area 129. The embodiment can provide better insulativity. FIG. 3C shows the situation where the insulating compositions 131a and 131b are repressed on the upper surface and the lower surface of the winding unit 100, thereby improving the insulativity of the winding unit and the magnetic core.

### Embodiment 3

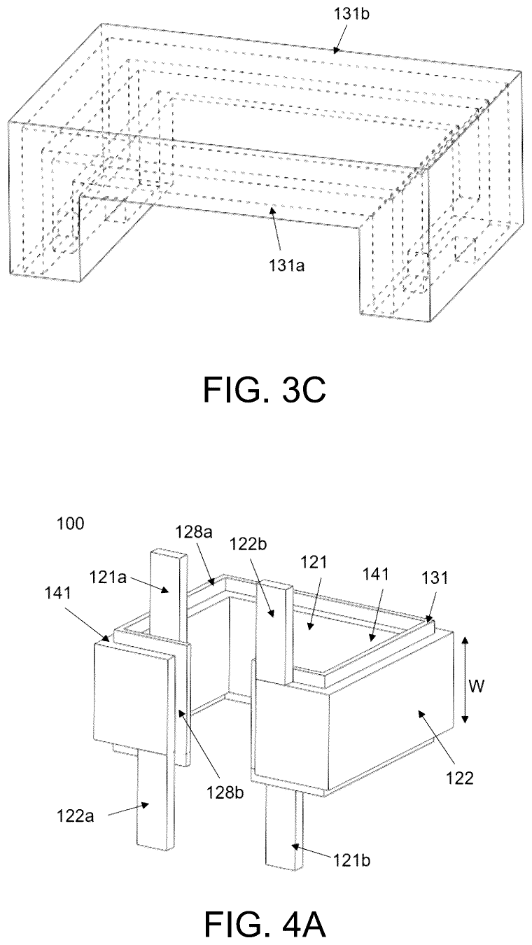

FIG. 4A is a schematic structural diagram of another embodiment of a winding unit, and FIG. 4B is a schematic structural diagram of another embodiment of an inductor structure. Referring to FIG. 4A to FIG. 4B, the difference between the embodiment and the first embodiment lies in that pins of the first winding 121 at two ends (a first end and a second end) are respectively located on opposite side faces of the winding unit, pins of the second winding 122 at two ends (a first end and a second end) are respectively located on opposite side faces of the winding unit, and pins of the first winding and the second winding at the same end are respectively located on opposite side faces of the winding unit. That is, the pin 121a of the first end of the first winding 121 is located on the first side face 141 of the first winding 121, and the pin 121b of the second end of the first winding 121 is located on the second side face of the first winding 121; and the pin 122a of the first end of the second winding 122 is located on the second side face of the second winding 122, and the pin 122b of the second end of the second winding 122 is located on the first side face of the second winding 122. The insulating composition 131 extends in a width direction W on the first side face 141 and the second side face to form a side extension 128a; the insulating composition 131 extends in the length direction on the first end surface and the second end to form an end surface extending part 128b. The pin 121a and the pin 122b are arranged on the top surface 211 of the inductor structure 200, and the pin 122a and the pin 121b are arranged on the bottom surface 213 of the inductor structure 200; and the winding unit is transversely arranged in the magnetic core 210. Optionally, the winding unit 100 is “C”-shaped. The side extension 128a and the end extension 128b can provide good insulation.

### Embodiment 4

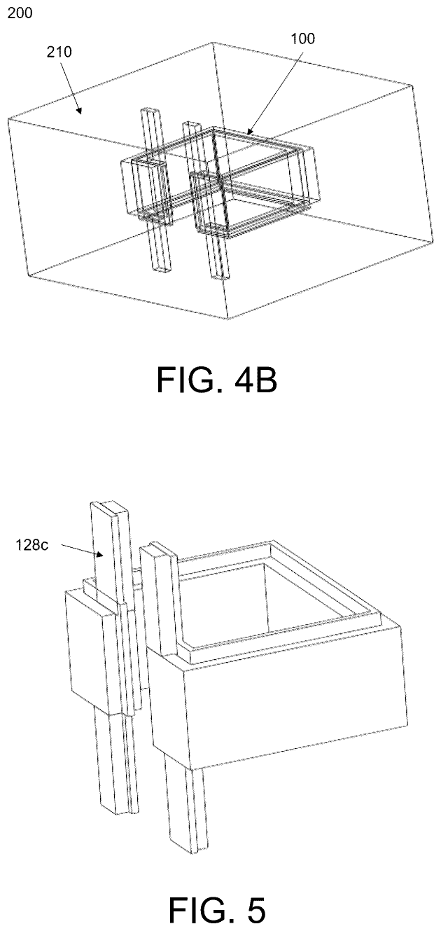

FIG. 5 is a schematic structural diagram of another embodiment of a winding unit. Referring to FIG. 5, the difference between the embodiment and the third embodiment lies in that the insulating composition also extends along the pins of the first winding and the second winding to form a pin extending part 128c, and optionally, the pin extending part 128c is arranged on all pins of the first winding and the second winding. Therefore, better insulativity is provided.

### Embodiment 5

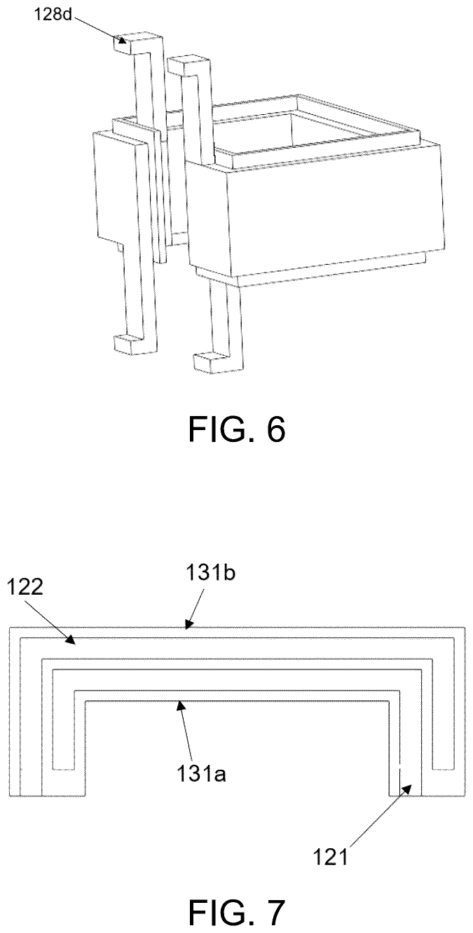

FIG. 6 is a schematic structural diagram of another embodiment of a winding unit. Referring to FIG. 6, the embodiment is different from the third embodiment in that the tail end of the pin of the first winding is provided with a bending part 128d; and the tail end of the pin of the second winding is provided with a bending part 128d, and the extending direction of the bending part is the same. Due to the fact that the winding unit is usually relatively thick, the lead-out position of the pin can be adjusted with low impedance.

### Embodiment 6

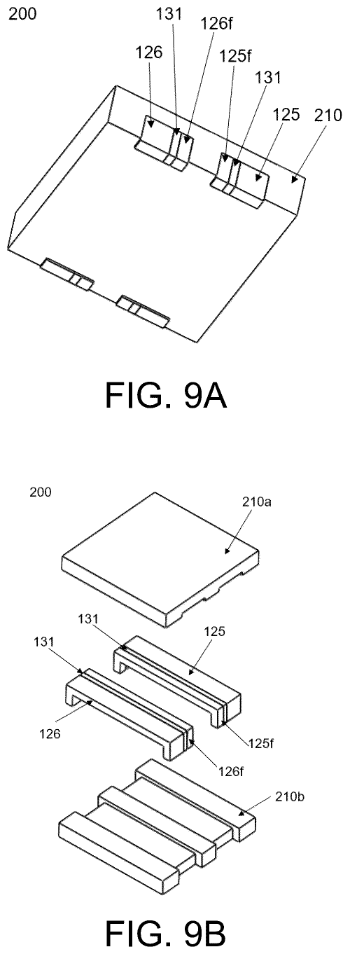

FIG. 8A is a schematic structural diagram of an embodiment of an inductor structure, and FIG. 8B is an exploded view of an inductor structure. Meanwhile, referring to FIG. 8A to 8B, the inductor structure 200 comprises a magnetic core 210 and a winding unit 100, the winding unit 100 comprises a first winding 121, a second winding 122 and an insulating composition 131, and the first winding 121 of the winding unit is a first main winding 121, the second winding 122 of the winding unit is a first auxiliary winding 121f, the first main winding 121, the insulating composition 131 and the first auxiliary winding 121f are stacked (arranged in parallel) in the width direction W of the inductor structure 200, and pins at the two ends of the first main winding and the first auxiliary winding are both located on the bottom surface of the inductor structure. The insulating composition 131 is arranged between the winding main bodies of the first main winding 121 and the first auxiliary winding 121f; and the geometric shapes of the first main winding and the first auxiliary winding are the same, so that the coupling coefficient between the main winding and the auxiliary winding is improved. Optionally, the winding unit is in a “[”-shape. The insulating composition is arranged between the first main winding and the first auxiliary winding to provide insulativity and prevent short circuit. The smaller the width of the insulating composition, the higher the coupling coefficient between the first main winding and the first auxiliary winding.

Optionally, the magnetic core comprises a first magnetic core 210a and a second magnetic core 210b; in the step S2, the winding unit and the magnetic core are co-pressed to form a combined body, the first magnetic core 210a, the winding unit and the second magnetic core 210b are assembled in sequence and then put into a mold, and the pressed to form a combined body. Grooves matched with the winding units in shape are formed in the first magnetic core and the second magnetic core. Specifically, for example, a magnetic core preformed semi-finished product (or referred to as a magnetic core blank), namely, a first magnetic core 210a and a second magnetic core 210b in FIG. 8B, is firstly manufactured; and then the magnetic core blank (equivalent to a first magnetic core 210a, a second magnetic core 210b) and a winding unit are assembled and then put into a mold for pressing.

Of course, optionally, co-pressed molding may also be to place the winding unit in the mold, fill the magnetic powder, and then directly press the winding unit and the magnetic powder to form the combined body; and the winding unit and the at least one magnetic core (such as a magnetic core blank) may also be placed in the mold, the magnetic powder material is filled, and then the winding unit, the at least one magnetic core (such as a magnetic core blank) and the magnetic powder are directly pressed to form the combined body. Specifically, for example, a magnetic core blank (such as a second magnetic core 210b) is firstly manufactured, then the magnetic core blank 210b and the winding unit are sequentially put into a mold, then magnetic powder is filled into the acupuncture points of the mold, and they are pressed and formed together.

The groove on the magnetic core blank is used for limiting the winding unit, so that the relative position of the winding unit is kept unchanged in the pressing process of the mold.

### Embodiment 7

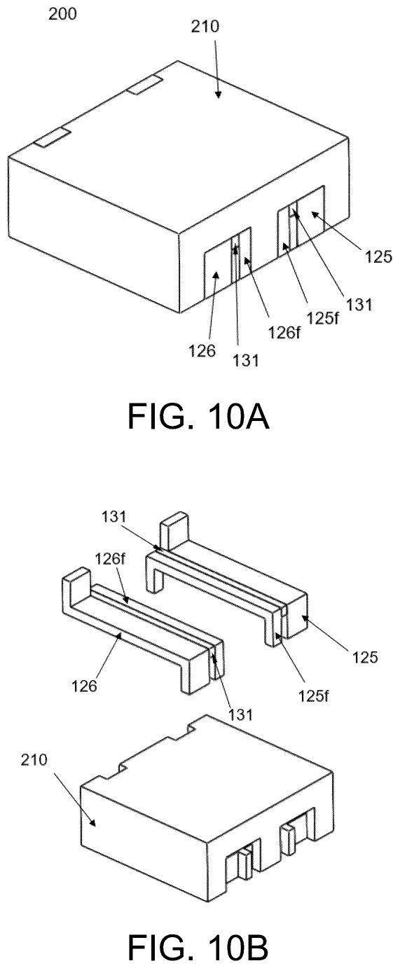

FIG. 9A is a schematic structural diagram of an embodiment of an inductor structure, and FIG. 9B is an exploded view of an inductor structure. Referring to FIG. 9A to FIG. 9B at the same time, the difference between the embodiment and the sixth embodiment lies in that the inductor structure 200 comprises a magnetic core 210 and a winding unit, and the winding unit 100 comprises a first winding unit and a second winding unit; a first winding of the first winding unit is a first main winding 125, and a second winding of the first winding unit is a first auxiliary winding 125f; a first winding of the second winding unit is a second main winding 126, and a second winding of the second winding unit is a second auxiliary winding 126f; and the first main winding 125, the insulating composition 131 and the first auxiliary winding 125f are stacked in the width direction W of the inductor structure 200; the second main winding 126, the insulating composition 131 and the second auxiliary winding 126f are stacked in the width direction W of the inductor structure 200; the first auxiliary winding and the second auxiliary winding are adjacent to each other at intervals in the width direction of the inductor structure; and specifically, in the step 2, the first winding unit and the second winding unit are arranged at intervals in the width direction of the inductor structure. The shape and extension direction of the first main winding 125 and the second main winding 126 are the same, and the shapes and extension directions of the first auxiliary winding 125f and the second auxiliary winding 126f are the same. Pins at two ends of the first main winding and the first auxiliary winding are both located on the bottom surface of the inductor structure; pins at two ends of the second main winding and the second auxiliary winding are both located on the bottom surface of the inductor structure. The cross-sectional area of the main winding is larger than that of the auxiliary winding, and the direct-current loss of the main winding is reduced.

### Embodiment 8

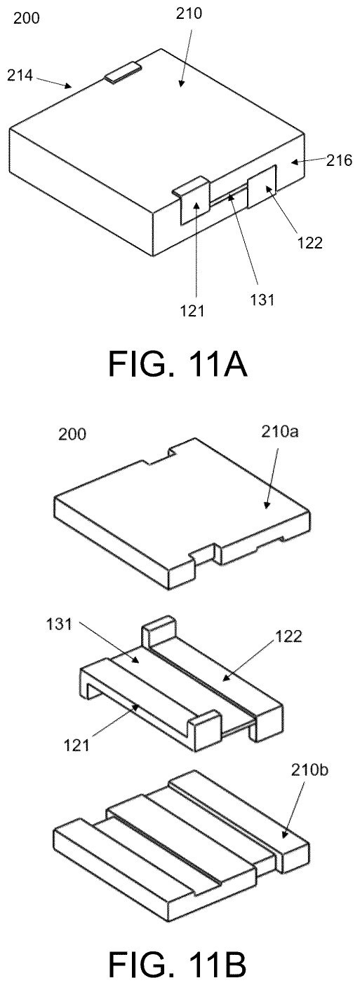

FIG. 10A is a schematic structural diagram of an embodiment of an inductor structure, and FIG. 10B is an exploded view of an inductor structure. Referring to FIG. 10A to FIG. 10B at the same time, the difference between the embodiment and the seventh embodiment lies in that pins of two ends (a first end and a second end) of the main winding (a first main winding 125 and a second main winding 126) are respectively located on the top surface and the bottom surface of the inductor structure, and pins at two ends of the first auxiliary winding 125f and the second auxiliary winding 126f are both located on the bottom surface of the inductor structure. In this way, the application range of the inductor structure is expanded.

### Embodiment 9

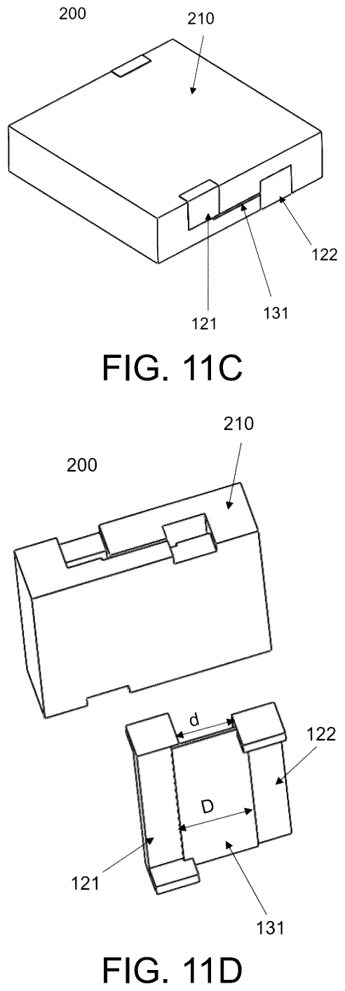

FIG. 11A is a schematic structural diagram of an embodiment of an inductor structure, and FIG. 11B is an exploded view of an inductor structure. Referring to FIG. 11A to FIG. 11B at the same time, the difference between the embodiment and the first embodiment lies in that the first main winding 121, the insulating composition 131 and the second winding 122 are stacked in the width direction W of the inductor structure, the insulating composition serves as a nonmagnetic air gap material between the first winding 121 and the second winding 122, and the coupling coefficient between the first winding and the second winding is adjusted by adjusting the thickness of the insulating composition. The insulating composition 131 is disposed between the main bodies of the first winding 121 and the second winding 122. A pin of one end (a first end) of the first winding 121 extends from a first side surface 214 to a bottom surface of the inductor structure, and a pin of the other end (a second end) of the first winding 121 extends from a second side surface 216 to a top surface of the inductor structure; a pin of one end (a first end) of the second winding 122 extends from a first side surface 214 to a top surface of the inductor structure, and a pin of the other end (a second end) of the second winding extends from a second side surface 216 to a bottom surface of the inductor structure. The insulating composition 131 serves as an air gap material to realize air gap manufacturing of the sintered inductor. The insulating composition and the sintered magnetic material have good compatibility, so that the problem that cracks are prone to being generated in the magnetic core in the air gap process of the sintered magnetic core can be solved.

In another embodiment of the embodiment, as shown in FIG. 11C-11D, different from Embodiment 9, the insulating composition 131 is arranged between the winding main bodies of the first winding 121 and the second winding 122 and has a width D; and the width W of the insulating composition 131 is larger than the distance D of the two windings in the width direction; in the manufacturing process of the inductor, it can be ensured that the insulating composition 131 completely covers the distance part between the two windings (the first winding 121 and the second winding 122). In this way, the purpose of arranging is to prevent the magnetic powder from extruding the insulating material 131 and the two windings in the pressing process of the inductor structure in FIG. 11A, to prevent magnetic short-circuit through the combination of the winding and the insulating composition.

### Embodiment 10

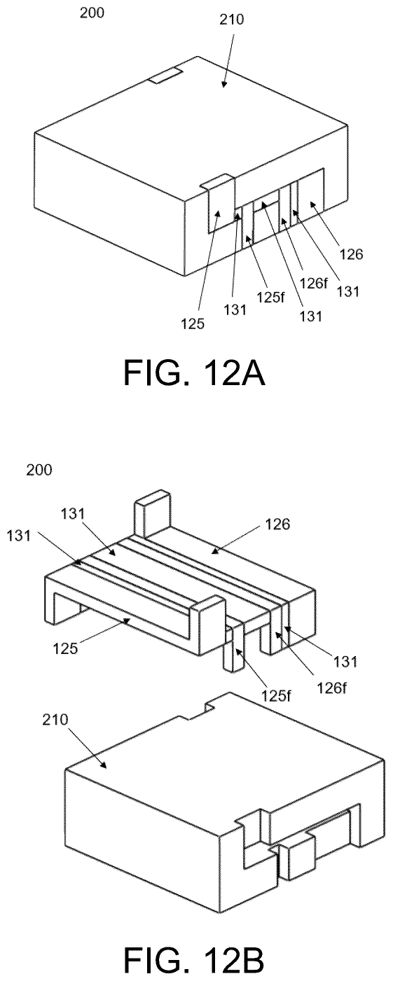

FIG. 12A is a schematic structural diagram of an embodiment of an inductor structure, and FIG. 12B is an exploded view of an inductor structure. Meanwhile, referring to FIG. 12A to 12B, the difference between the embodiment and the eighth embodiment lies in that an insulating composition 131 is further arranged at the interval between the first winding unit and the second winding unit, the insulating composition 131 serves as a nonmagnetic air gap material between the first winding unit and the second winding unit, and the coupling coefficient between the first winding unit and the second winding unit is adjusted by adjusting the thickness of the insulating composition. The shape and extension direction of the first auxiliary winding 125f and the second auxiliary winding 126f are the same; a pin at one end of the first main winding 125 extends from a first side surface to a bottom surface of the inductor structure, and a pin at the other end of the first main winding 125 extends from a second side surface to a top surface of the inductor structure; a pin at one end of the second main winding 126 extends from a first side surface to a top surface of the inductor structure, and a pin at the other end of the second main winding 126 extends from a second side surface to a bottom surface of the inductor structure. The insulating composition 131 serves as an air gap material to achieve air gap manufacturing of the sintered inductor. Since the insulating composition and the sintered magnetic material have good compatibility, the problem that cracks are prone to being generated in the magnetic core in the air gap process of the sintered magnetic core can be solved.

### Embodiment 11

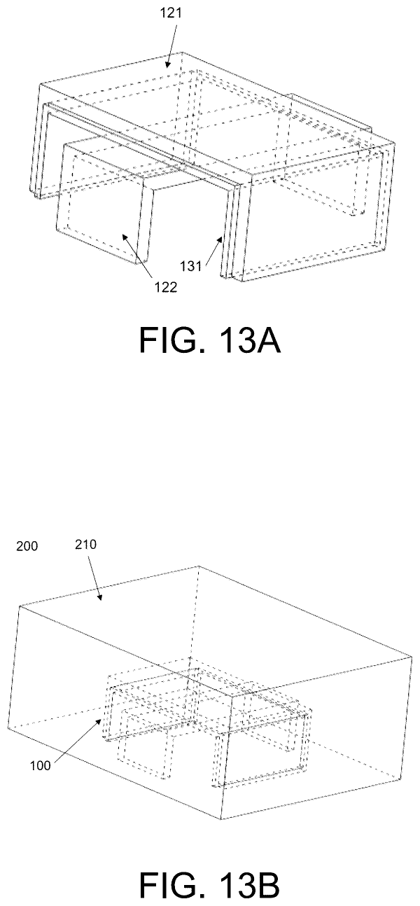

As shown in FIGS. 13A-13B, the present application further provides a method for forming an inductor structure 200, comprising following steps.

S1, providing at least one insulating composition 131, at least one first winding 121 and at least one second winding 122.

S2, integrating the first winding 121 and the insulating composition 131, and then performing pressing molding to form an integrated body; pressing and forming the second winding 122.

S3, bonding the integrated body with the second winding 122 through an organic material to form a winding unit 100, wherein an insulating composition 133 of the winding unit is located between the first winding and the second winding.

The organic material is at least one of organic silicon, epoxy resin, polyvinyl alcohol, polyester, polyesterimide, polyimide and polyamide imide.

S4, co-pressing at least one of the winding units and at least one magnetic core 210 to form a combined body.

S5, performing high-temperature annealing on the combined body.

S6, impregnating the annealed combined body into an organic material.

S7, leading out pins to form an inductor structure, wherein the inductor structure comprises a top surface, a bottom surface, a first side surface and a second side surface opposite to the first side surface.

The method of the embodiment differs from the method for forming the inductor structure in the following steps: step S2 and step S3. In the embodiment, the first winding 121 and the insulating composition 131 are firstly pressed, and then the first winding 121 and the insulating composition 131 are combined with the second winding 122. In addition, different points of the inductor structure in the embodiment and the first embodiment are that pins at the two ends of the first winding and the second winding are both located on the bottom surface of the inductor structure; and the main bodies of the first winding 121 and the second winding 122 intersect with each other. Optionally, the angle of the main bodies intersecting each other is 90°.

### Embodiment 12

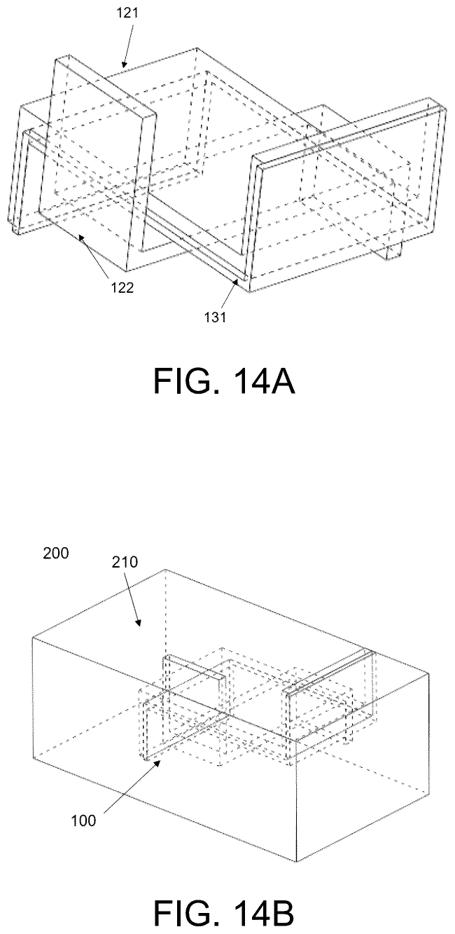

FIG. 14A is a schematic structural diagram of an embodiment of an inductor structure, and FIG. 14B is an exploded view of an inductor structure. Referring to FIG. 14A to FIG. 14B at the same time, the difference between the embodiment and the eleventh embodiment lies in that a pin at one end of the first winding 121 is located on the bottom surface of the inductor structure, and a pin at the other end of the first winding 121 is located on the top surface of the inductor structure; the pin at one end of the second winding 122 is located on the top surface of the inductor structure, and the pin at the other end of the second winding 122 is located on the bottom surface of the inductor structure.

### Embodiment 13

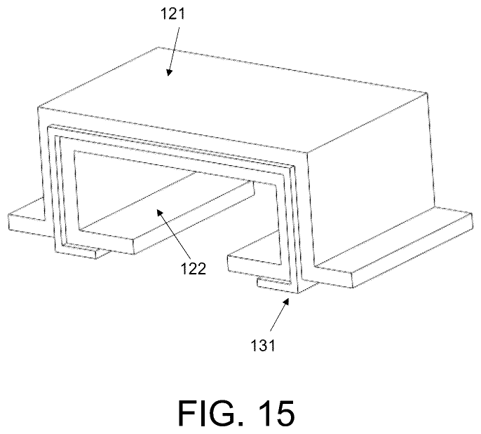

FIG. 15 is a schematic structural diagram of an embodiment of an inductor structure.

Referring to FIG. 15, the difference between the embodiment and the eleventh embodiment lies in that pins at two ends of the first winding 121 and the second winding 122 are both located on the bottom surface of the inductor structure 200; and the main bodies of the first winding, the insulating composition and the second winding are sequentially stacked. Pins located at the same end of the first winding 121 and the second winding 122 extend away from each other, pins at two ends of the first winding 121 and the second winding 122 do not cover the insulating composition 131, and the insulating composition 131 only extends along the bending part of the first winding.

According to the embodiment, the inductor structure 200 can be applied to an independent voltage adjusting module or a part of the electronic device as long as the technical features and advantages disclosed by the application are met.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%. In addition, relational terms such as first and second are used herein to distinguish one entity or operation from another entity or operation, and do not necessarily require or imply that there is any such actual relationship or sequence between these entities or operations. Moreover, the terms “comprising,” “including,” or any other variation thereof are intended to cover a non-exclusive inclusion, such that a process, method, article, or device that includes a series of elements includes not only those elements, but also other elements that are not explicitly listed, or elements inherent to such a process, method, article, or device. In the absence of more restrictions, a statement” comprising one. A defined element does not preclude the existence of additional identical elements in the process, method, article, or device that includes the element.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. An insulating composition, used in a winding unit or between different winding units of an inductor structure, comprising:
a fiber base material for providing the strength of the insulating composition; and
an organic matter, wherein the organic matter covers the fiber base material and is used for providing stress buffering,
wherein the resistivity of the insulating composition after annealing is greater than or equal to 2 Mohm·m.

2. The insulating composition of claim 1, wherein a melting temperature of the fiber base material is smaller than an annealing temperature, and a cracking temperature of the organic matter is smaller than the melting temperature of the fiber base material.

3. The insulating composition of claim 1, wherein at a normal temperature, a tensile strength in an extension direction of the fiber base material on a plane of the insulating composition is greater than or equal to 20 MPa.

4. The insulating composition of claim 1, wherein the fiber base material is at least one of glass fiber and ceramic fiber, and the organic matter is at least one of organic silicon, epoxy resin, polyvinyl alcohol, polyester, polyesterimide, polyimide and polyamide imide.

5. The insulating composition of claim 1, wherein the fiber base material is a glass fiber braided fabric, and the organic matter is an organic silicon resin.

6. The insulating composition of claim 5, wherein the glass fiber braided fabric comprises warp yarns formed by a plurality of strands of fibers and weft yarns formed by a plurality of strands of fibers, and the organic silicon resin covers the periphery of the glass fiber braided fabric and is formed in the glass fiber braided fabric.

7. The insulating composition of claim 1, wherein at a normal temperature, the compressive strength of the organic matter is greater than or equal to 1.5 GPa.

8. A method for forming a winding unit, comprising the following steps:
a step S1, providing at least one insulating composition according to claim 1;
a step S2, forming a first winding connecting piece on a first surface of the at least one insulating composition, and forming a second winding connecting piece on a second surface opposite to the first surface to form a combined connecting piece;
a step S3, separating the combined connecting piece into at least one winding unit; and
a step S4, pressing and forming the winding unit to form the winding unit, wherein the winding unit comprises a first winding, an insulating composition and a second winding which are sequentially stacked.

9. The method for forming the winding unit of claim 8, wherein in the step S2, the combined connecting piece is formed in a pressing mode.

10. The method for forming the winding unit of claim 8, wherein in the step S2, after the combined connecting piece is formed, a pattern is formed on the first winding connecting piece and the second winding connecting piece.

11. The method for forming the winding unit of claim 8, wherein in the step S2, a pattern is formed on the first winding connecting piece and the second winding connecting piece before the combined connecting piece is formed.

12. The method for forming the winding unit of claim 8, wherein in the step S2, the insulating composition is one, the first winding connecting piece is only a discrete first winding, and the second winding connecting piece is only a discrete second winding.

13. The method for forming the winding unit of claim 12, wherein in the step S2, the combined connecting piece is formed to assemble the first winding, the insulating composition and the second winding.

14. The method for forming the winding unit of claim 8, wherein in the step S2, the insulating composition is laminated on the upper surface and the lower surface of the combined connecting piece.

15. A method for forming an inductor structure comprising the following steps:
a step S1, providing at least one winding unit formed by the method for forming the winding unit according to claim 8, and providing at least one magnetic core or a magnetic core material;
a step S2, co-pressing the at least one winding unit and the at least one magnetic core or the magnetic core material to form a combined body;
a step S3, performing high-temperature annealing on the combined body;
a step S4, impregnating the annealed combined body into an organic material; and
a step S5, leading out pins to form an inductor structure, the inductor structure comprising a top surface, a bottom surface, a first side surface, and a second side surface opposite to the first side surface.

16. The method for forming the inductor structure of claim 15, wherein the first winding and the second winding of the winding unit in the step S1 comprise a first end and a second end, and pins are arranged at the two ends of the first winding and the second winding.

17. The method for forming the inductor structure of claim 16, wherein pins at both ends of the first winding and the second winding are both located on the bottom surface of the inductor structure.

18. The method for forming the inductor structure of claim 16, wherein projections of the pins at the same end of the first winding and the second winding do not overlap with each other in the thickness direction of the winding unit.

19. The method for forming the inductor structure of claim 15, wherein the winding unit comprises a first main surface and a second main surface which are opposite to each other, the winding unit further comprises a first side face and a second side face which are opposite, the first side face and the second side face are arranged on the side face of the main surface respectively, the winding unit further comprises a first end face and a second end face which are opposite, and the first end face and the second end face are arranged on the end face of the main surface respectively.

20. The method for forming the inductor structure of claim 16, wherein a bending part is arranged at the tail end of a pin of the first winding; and a bending part is arranged at the tail end of a pin of the second winding.

21. The method for forming the inductor structure of claim 15, wherein a first winding of the winding unit is a first main winding, a second winding of the winding unit is a first auxiliary winding, and the first main winding, the insulating composition and the first auxiliary winding are stacked in a width direction of the inductor structure, and pins at two ends of the first main winding and the first auxiliary winding are both located on a bottom surface of the inductor structure.

22. The method for forming the inductor structure of claim 15, wherein the at least one winding unit comprises a first winding unit and a second winding unit; a first winding of the first winding unit is a first main winding, and a second winding of the first winding unit is a first auxiliary winding; a first winding of the second winding unit is a second main winding, and a second winding of the second winding unit is a second auxiliary winding;
the first main winding, the insulating composition and the first auxiliary winding are stacked in the width direction of the inductor structure, and the second main winding, the insulating composition and the second auxiliary winding are stacked in the width direction of the inductor structure;
the first auxiliary winding and the second auxiliary winding are adjacent in the width direction of the inductor structure at intervals; and
in the step S2, the first winding unit and the second winding unit are arranged at intervals in the width direction of the inductor structure.

23. The method for forming the inductor structure of claim 22, wherein the first main winding and the second main winding have the same shape and extension direction, and the first auxiliary winding and the second auxiliary winding have the same shape and extension direction.

24. The method for forming the inductor structure of claim 23, wherein pins at both ends of the first main winding and the first auxiliary winding are both located on the bottom surface of the inductor structure; and pins at both ends of the second main winding and the second auxiliary winding are both located on the bottom surface of the inductor structure.

25. The method for forming the inductor structure of claim 23, wherein pins at two ends of the main winding are respectively located on a top surface and a bottom surface of the inductor structure, and pins at two ends of the first auxiliary winding and the second auxiliary winding are both located on a bottom surface of the inductor structure.

26. The method for forming the inductor structure of claim 15, wherein the first winding, the insulating composition and the second winding are stacked in the width direction of the inductor structure, the insulating composition serves as a nonmagnetic air gap material between the first winding and the second winding, and the coupling coefficient between the first winding and the second winding is adjusted by adjusting the thickness of the insulating composition.

27. The method for forming the inductor structure of claim 26, wherein a pin at one end of the first winding extends from a first side surface to a bottom surface of the inductor structure, and a pin at the other end of the first winding extends from a second side surface to a top surface of the inductor structure; the pin at one end of the second winding extends from the first side surface to the top surface of the inductor structure, and the pin at the other end of the second winding extends from the second side surface to the bottom surface of the inductor structure.

28. The method for forming the inductor structure of claim 27, wherein the insulating composition has a width, and the width of the insulating composition is greater than the distance between the first winding and the second winding in the width direction.

29. The method for forming the inductor structure of claim 23, wherein the insulating composition is further arranged at the interval between the first winding unit and the second winding unit, the insulating composition serves as a nonmagnetic air gap material between the first winding unit and the second winding unit, and the coupling coefficient between the first winding unit and the second winding unit is adjusted by adjusting the thickness of the insulating composition.

30. The method for forming the inductor structure of claim 29, the shape and extension direction of the first auxiliary winding and the second auxiliary winding are the same; the pin at one end of the first main winding extends from the first side surface to the bottom surface of the inductor structure, and the pin at the other end of the first main winding extends from the second side surface to the top surface of the inductor structure; a pin at one end of the second main winding extends from the first side surface to the top surface of the inductor structure, and a pin at the other end of the second main winding extends from the second side surface to the bottom surface of the inductor structure.

31. The method for forming the inductor structure of claim 21, wherein in the step S1, the provided at least one magnetic core comprises a first magnetic core and a second magnetic core, or the magnetic powder is provided as a magnetic core material; in the step S2, the winding unit and the magnetic core or the magnetic powder are co-pressed to form the combined body, wherein the first magnetic core, the winding unit and the second magnetic core are assembled in sequence and then put into a mold, and is pressed to form the combined body; or the winding unit is placed in the mold, the magnetic powder is filled, and then the winding unit and the magnetic powder are directly pressed to form the combined body.

32. The method for forming the inductor structure of claim 31, wherein the first magnetic core and the second magnetic core are both provided with grooves adapted to the shape of the winding unit.

33. A method for forming an inductor structure, comprising:
a step S1, providing at least one insulating composition, at least one first winding and at least one second winding according to claim 1;
a step S2, integrating the first winding and the insulating composition, and then performing a pressing molding to form an integrated body; and pressing and forming the second winding;
a step S3, bonding the integrated body with the second winding through an organic material to form a winding unit, wherein the insulating composition of the winding unit is located between the first winding and the second winding;
a step S4, co-pressing at least one of the winding units and at least one magnetic core or magnetic core material to form a combined body;
a step S5, performing high-temperature annealing on the combined body;
a step S6, impregnating the annealed combined body into an organic matter; and
a step S7, leading out pins to form an inductor structure, the inductor structure comprising a top surface, a bottom surface, a first side surface, and a second side surface opposite to the first side surface.

34. The method for forming the inductor structure of claim 33, wherein the first winding and the second winding of the winding unit in the step S4 comprise a first end and a second end, and pins are arranged at the two ends of the first winding and the second winding.

35. The method for forming the inductor structure of claim 34, wherein pins at both ends of the first winding and the second winding are both located on a bottom surface of the inductor structure, and main bodies of the first winding and the second winding intersect with each other.

36. The method for forming the inductor structure of claim 34, wherein a pin at one end of the first winding is located on the bottom surface of the inductor structure, and a pin at the other end of the first winding is located on the top surface of the inductor structure; a pin at one end of the second winding is located on the top surface of the inductor structure, and a pin at the other end of the second winding is located on the bottom surface of the inductor structure.

37. The method for forming the inductor structure of claim 36, wherein pins at both ends of the first winding and the second winding are located on the bottom surface of the inductor structure; and the main bodies of the first winding, the insulating composition and the second winding are sequentially stacked.

38. The method for forming the inductor structure of claim 37, wherein pins located at the same end of the first winding and the second winding extend away from each other, pins at both ends of the first winding and the second winding do not cover the insulating composition, and the insulating composition only extends along the bending portion of the first winding.
